(19) United States
(12) Patent Application Publication
(10) Pub. No.: US 2016/0003375 A1
(43) Pub. Date: Jan. 7, 2016

(54) VERSATILE HANGING SYSTEM FOR ROOF SUPPORT SYSTEMS

(71) Applicant: Roy Lee Robertson, JR., Delbarton, WV (US)

(72) Inventor: Roy Lee Robertson, JR., Delbarton, WV (US)

(21) Appl. No.: 14/789,153

(22) Filed: Jul. 1, 2015

Related U.S. Application Data
(60) Provisional application No. 62/019,485, filed on Jul. 1, 2014.

(51) Int. Cl. F16L 3/02; F16M 13/02

(52) U.S. Cl. CPC F16L 3/02; F16M 13/02

(57) ABSTRACT

A versatile hanging system for use with a roof support system, which includes an attachment mechanism configured to secure within the eye hole of a roof plate. The attachment mechanism has a horizontal support and a vertical support, with an engaging structure at a first end of the vertical support. In one embodiment the horizontal support includes a multi-curved, multi-segmented design to secure within the eye hole of a roof plate; in another embodiment the horizontal support has a tapered depth. The system of the present invention may further include a hanging mechanism having an upper elbow and a vertical bar, with an aperture along an upper portion of the upper elbow. The lower portion of this aperture is sized and shaped to receive the engaging structure of the attachment mechanism, and the upper portion of the aperture is sized and shaped to rotate about the vertical support of the attachment mechanism. In some embodiments the hanging mechanism is in the form of a j-hook, having a lower elbow.

### BACKGROUND OF THE INVENTION

The present invention regards a versatile hanging system for roof support systems used in underground mines.

By means of the present invention, various lines, hoses, waterline curtains, cables, cords, reflectors, lifelines and equipment may be hung from or strung among the roof plates of roof support systems installed within underground mines. Presently, most of these items are hung from the roof support systems; however, the hanging fixtures used to support such items are not always affixed securely to the roof support system so as to be able to provide sufficient support for heavier items, or may cause the items to be high above the ground (at the roof level), requiring a ladder to install, remove, or repair the same.

### SUMMARY OF THE INVENTION

The present invention regards a versatile hanging system for use with a roof support system having a plurality of roof plates, each with one or more eye holes incorporated on the exposed surface thereof. The system includes an attachment mechanism configured to secure within the eye hole of a roof plate. This attachment mechanism has a horizontal support and a vertical support. The vertical support has an engaging structure at a first end thereof. In one embodiment the horizontal support has a curved portion extending from a second end of the vertical support, leading to a first segment, continuing into a second curve and extending into a second segment, and ending in a third segment extending above horizontal. In another embodiment the horizontal support is affixed to the vertical support at a point a distance from the top of the vertical support, the distance being about the thickness of the roof plate, and the horizontal support has a tapered height, tapering from its affixation with the vertical support to the opposing end of the horizontal support.

The system of the present invention may further include a hanging mechanism having an upper elbow and a vertical bar, with an aperture along an upper portion of the vertical bar and extending to a portion of the upper elbow. The lower portion of the aperture along the vertical bar is sized and shaped to receive the engaging structure of the attachment mechanism, and the upper portion of the aperture along the upper elbow is sized and shaped to rotate about the vertical support of the attachment mechanism. In some embodiments the hanging mechanism is in the form of a j-hook, also having a lower elbow.

### DESCRIPTION OF THE FIGURES

FIG. 1 is a perspective view of an embodiment of the attachment mechanism of the present invention, installed in the eye-hole of a roof plate, with a j-hook of an embodiment of the present invention separated from to the attachment mechanism.

FIG. 2 is a perspective view of the embodiment of the system of the present invention shown in FIG. 1, with the j-hook attached to the attachment mechanism.

FIG. 3 is a perspective view of another embodiment of the attachment mechanism of the present invention, being installed in the eye-hole of a roof plate, with a j-hook of an embodiment of the present invention attached to the attachment mechanism.

FIG. 4 is a perspective view of the embodiment of the system of the present invention shown in FIG. 3, wherein the attachment mechanism is installed in the eye-hole of the roof plate.

FIG. 5 is a side view of an embodiment of the attachment mechanism of the present invention.

FIG. 6 is a side view of another embodiment of the attachment mechanism of the present invention.

FIG. 7 is a perspective view of another embodiment of the attachment mechanism of the present invention.

FIG. 8A is a perspective view of an embodiment of a j-hook of the system of the present invention.

FIG. 8B is a perspective view of an embodiment of a straight plate of the system of the present invention.

FIG. 8C is a perspective view of another j-hook of a system of the present invention.

FIG. 8D is a perspective view of another embodiment of a straight plate of the system of the present invention.

FIG. 9 is a perspective view of another embodiment of a j-hook of the system of the present invention.

FIG. 10 is a perspective view of another embodiment of a system of the present invention.

### DETAILED DESCRIPTION OF THE INVENTION

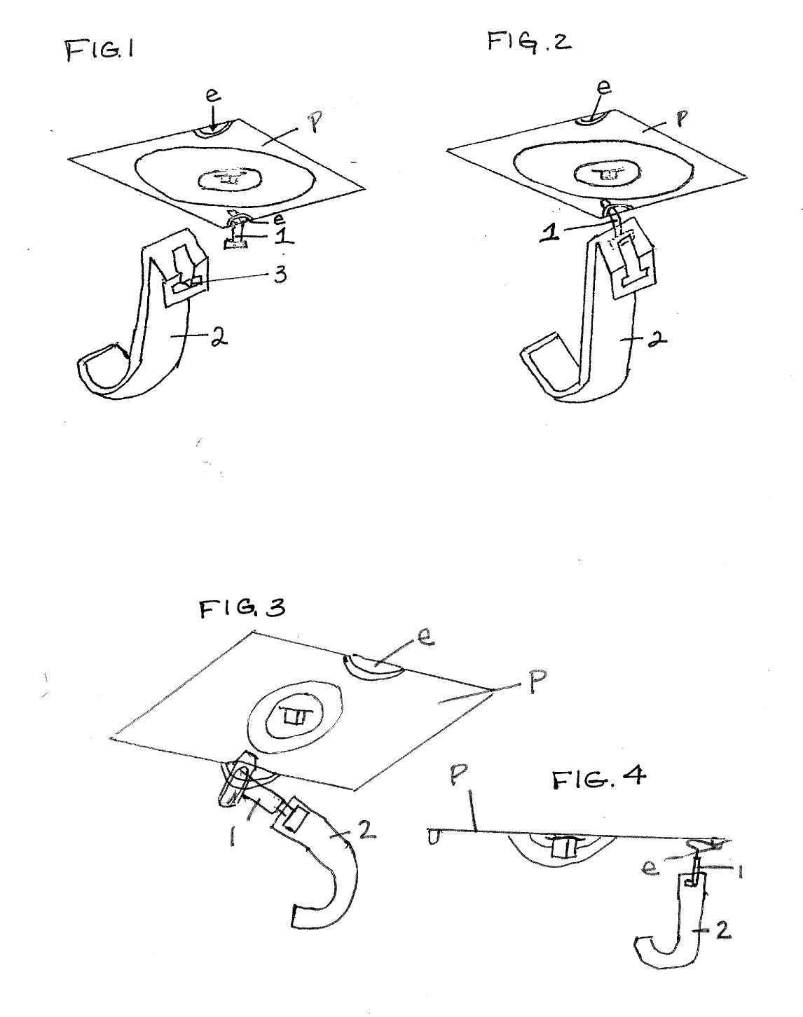

The present invention provides a versatile hanging system to securely affix lines, hoses, waterline curtains, cables, cords, reflectors, lifelines and equipment, to the roof support systems of underground mines. These roof support systems comprise a plurality of roof plates bolted into the mine roof. Each plate P (shown in FIGS. 1-4) has a plurality of eye holes e positioned near the corners or on the sides of the plates. The system of the present invention comprises an attachment mechanism 1 intended to be received in and secured to an eye-hole e of a roof plate P; in some embodiments the system of the present invention comprises a j-hook or other hanging support member 2. The attachment mechanism 1 as shown in FIGS. 5-7 comprises, generally, a vertical support 1B and a horizontal support 1C. The horizontal and vertical supports may be formed as a unitary component, or may be welded together or otherwise affixed.

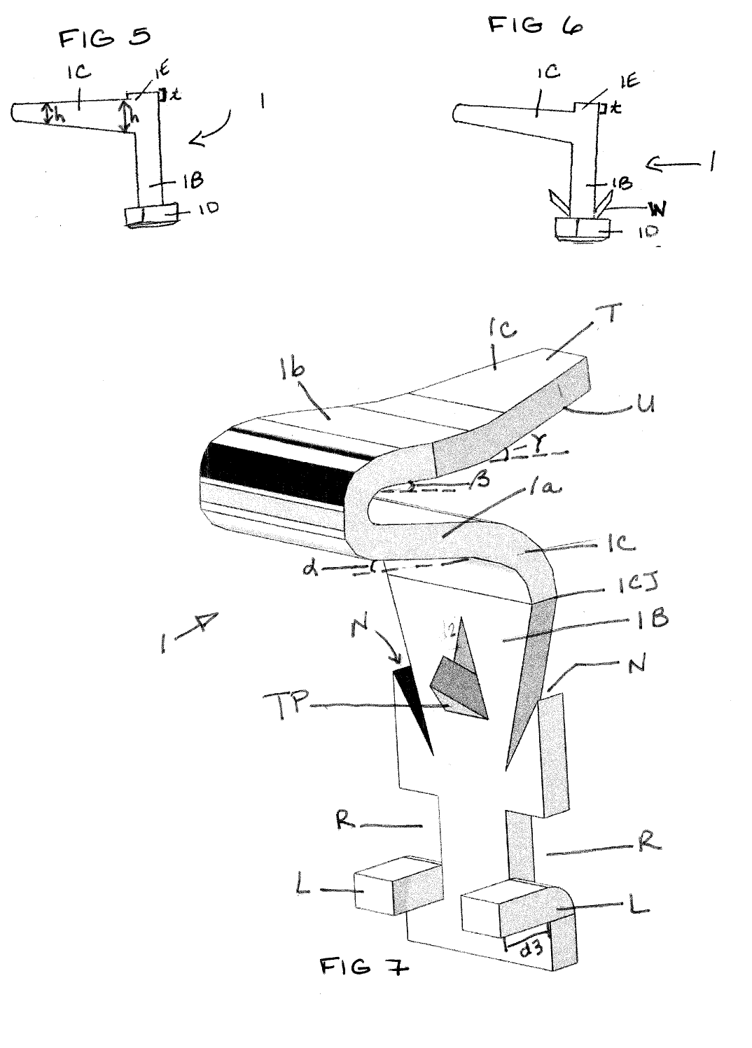

In some embodiments (shown in FIGS. 3, 4, 7 and 10), the horizontal support 1C of the attachment mechanism 1 has multiple curves and segments, joining the vertical support 1B of the attachment mechanism 1 at a point 1CJ. As shown in the figures, from the point 1CJ the support has a first curve, leading to a first segment 1a extending above horizontal at an angle α, continuing into a second curve, extending into a second segment 1b at an angle β of decline below horizontal, and ending in a third segment 1c extending above horizontal at an angle γ. In this embodiment the angle α may be between about 8°-16°, or 10-14°, or 12°, the angle β may be between about 2°-10°, or about 4°-8°, or about 6°, and the angle γ may be between about 1°-9°, or about 3° -7° or about 5°. The width of segments 1a and 1b is preferably about 1″; the width of segment 1c tapers along its length from about 1″ to about 0.2″ to 0.5″, or about 0.3″. By this configuration a portion of segment 1c may be securely and removably received in the eye-hole e of the plate P, so that when in position the topside T of the end thereof is in contact with the plate P, while the underside U of the segment is in contact with the interior surface of the eye-hole e, as shown in FIG. 4.

In this embodiment, the vertical support 1B has an engaging structure at the bottom end of the support, and comprises a rectangular bar which may have one or more angular notches N cut out or formed on the sides thereof. In some embodiments the horizontal support further comprises a triangular prism TP extending from the body of the rectangular bar. In some embodiments one or more rectangular recesses R are cut into or formed on the side(s) of the rectangular bar, with a ledge L extending from the bottom portion of each rectangular recess forming the engaging structure. The backs of these ledges may have a rounded edge. The triangular prism may extend out by a distance d2 of about 0.14″ from the surface of the vertical support 1B, and the ledges may extend out by a distance d3 of about 0.35″ from the face of the vertical support 1B; these extending members may be formed from the rectangular bar, by cutting all but the lower edge of the member from the rectangular bar, and bending the member about the lower edge. Alternatively, these extending members may be welded to the rectangular bar.

In other embodiments (shown in FIGS. 1, 2, 5 and 6), the solid vertical support 1B of the attachment mechanism 1 may be cylindrical in shape. Extending from the solid vertical support at a distal end is an engaging member, such as a bolt head 1D. In this embodiment the horizontal support 1C has a tapered height h sized to be tightly received within the eyehole e of a roof plate P of a roof support system. The horizontal support 1C may have a circular cross-section at the point of affixation to said vertical support 1B, tapering into a semi-circular cross section at the distal end of said horizontal support. The horizontal support 1C is affixed below the top 1E of the vertical support 1B, by a distance of about the thickness t of the plate P, so that when installed within the eyehole of a roof plate the attachment mechanism 1 is supported by both the surface of the plate (where the horizontal support 1C rests on the plate) and by the roof (where the top 1E of the vertical support 1B rests on the roof).

As shown in FIGS. 1 and 2, the attachment mechanism 1 of this embodiment is installed by inserting the horizontal support 1C of the attachment mechanism into the eyehole e of the plate P (installed into a mine roof), and applying force to the attachment mechanism 1 so that the horizontal support 1C is secure within said eyehole e, and the proximal portion 1E of said vertical support is pressed up against the mine roof. The attachment mechanism 1 can be removed from the eyehole e by applying force to the mechanism in the opposite direction.

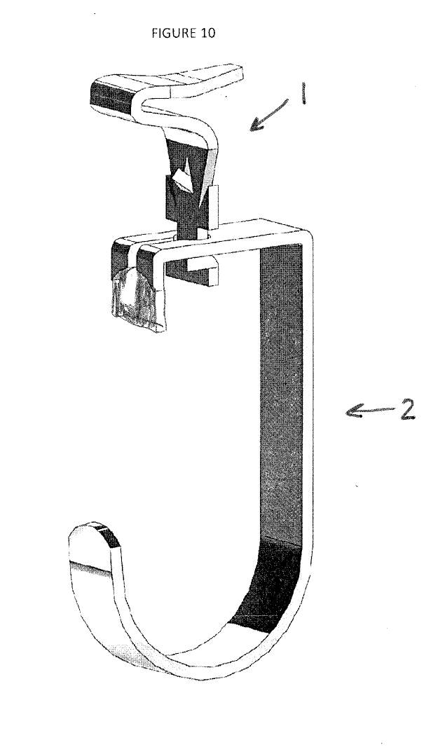

As shown in FIGS. 8A and 9, in some embodiments the j-hook 2 of the system of the present invention comprises an aperture along a lip of the upper elbow, and extending to the top surface of the upper elbow, wherein the lower portion 3A of the aperture along the elbow lip is sized to receive the engaging mechanism of the attachment mechanism, and the upper portion of the aperture 3B along the top surface of the upper elbow is sized to allow the rotation of the j-hook about the vertical support of the attachment mechanism (about, for example, the recessed portions thereof formed by the rectangular recesses R, as shown in FIG. 10), but smaller than the engaging mechanism to rotatably secure the j-hook with the attachment mechanism. The portion of the aperture between the apertures 3A and 3B is sized and configured to allow the vertical bar to pass therethrough and position the j-hook as herein described (i.e., having dimensions greater than the width or depth of the rectangular bar of the vertical support at the recessed areas).

As shown in FIGS. 3, 4, 9 and 10, when used with the embodiment of the attachment mechanism shown in FIGS. 3, 4 and 7, the aperture 3A is sized to receive the ledge(s) L. As shown in FIGS. 1, 2 and 8A, when used with the embodiment of the attachment mechanism shown in FIGS. 1, 2, 5 and 6, the aperture is in the shape of a keyhole, sized and configured to receive the bolt head 1D of the attachment mechanism 1. After receiving the ledge or bolt head, the j-hook may be pivoted about the vertical support 1B, in the direction ρ, so that the j-hook is supported and secured at its upper elbow 3B to the vertical support, as shown in FIGS. 2, 4 and 10. The lower elbow 2B of the j-hook can be used to support waterline curtains, cables, reflectors, lifelines and other lines and equipment in mines.

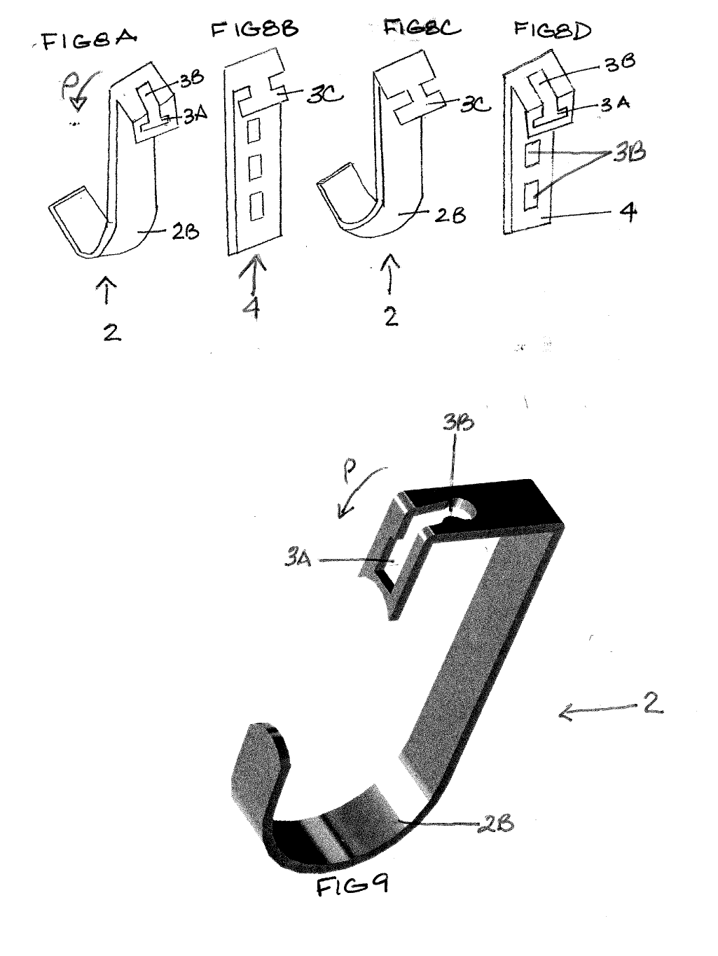

In one embodiment, shown in FIG. 6, three or more spikes W may extend from the head 1 D to support waterline curtains.

In some embodiments shown in FIGS. 8A-D the aperture 3A is positioned on a straight plate 4. In this embodiment the aperture 3A is sized and configured to receive the ledges L or bolt head 1D of the attachment mechanism 1 as hereinabove described in the embodiments of the j-hook. The straight plate 4 may have an upper elbow, and a plurality of apertures 3B to receive multiple j-hooks or straight plates affixed thereto by means of a t-shaped end 3C or bolt head 1D incorporated into such hooks or plates corresponding with and sized and configured to be received by the apertures 3B positioned through such straight plate 4. By this configuration multiple j-hooks or other supporting structures can be hung from a single attachment mechanism 1 when the system is affixed to a roof plate P as hereinabove described.

The system of the present invention may be installed on a roof plate P by securing the horizontal support of the attachment mechanism 1 within the eyehole e of the roof plate. The j-hook 2 is then installed on the attachment mechanism by inserting the engaging mechanism, e.g., ledges L or head 1D, into the aperture 3A of the straight plate 4, and pivoting the j-hook in the direction ρ about the vertical support 1B of the attachment mechanism, so that the vertical support extends through the aperture 3B, and the underside of the upper elbow of the j-hook is supported by the engaging mechanism.

Notably, in each of these embodiments the j-hooks 2 and straight plates 4 are freely rotatable relative to the roof plate and the attachment mechanism 1.

Once installed, the system of the present invention is capable of supporting lines, hoses, waterline curtains, cables, cords, reflectors, lifelines and equipment, by means of the roof support systems of underground mines.

1. A versatile hanging system for use with a roof support system, having a plurality of roof plates with eye holes, the system comprising an attachment mechanism configured to secure within the eye hole of the roof plate, wherein the mechanism comprises:
a. a horizontal support and a vertical support;
b. wherein the vertical support has an engaging structure at a first end thereof; and
c. wherein the horizontal support comprises a curved portion extending from a second end of the vertical support, leading to a first segment extending above horizontal at an angle α, continuing into a second curve, extending into a second segment at an angle β of decline below horizontal, and ending in a third segment extending above horizontal at an angle γ.

2. The versatile hanging system of claim 1, wherein the angle α is between about 8°-16°, the angle β is between about 2°-10°, and the angle γ is between about 1°-9°.

3. The versatile hanging system of claim 1, wherein the angle α is between about 10-14°, the angle β is between about 4°-8°, and the angle γ is between 3°-7°.

4. The versatile hanging system of claim 1, wherein the engaging structure comprises one or more ledges extending from a face of the vertical support.

5. The versatile hanging system of claim 1, wherein the vertical support further comprises a plurality of notches along opposing sides of the vertical support.

6. The versatile hanging system of claim 5, wherein the vertical support further comprises a triangular prism extending from a face of the vertical support.

7. The versatile hanging system of claim 4, further comprising a j-hook having an upper elbow with a lip, a vertical bar, and a lower elbow, with an aperture along a portion of the lip and extending to a portion of the upper elbow, the lower portion of the aperture along the lip being sized to receive the ledge of the attachment mechanism, and the upper portion of the aperture along the upper elbow being sized to rotate about a portion of the vertical support of the attachment mechanism.

8. The versatile hanging system of claim 1, further comprising a hanging mechanism having an upper elbow with a lip and a vertical bar, with an aperture along the lip and extending to a portion of the upper elbow, the lower portion of the aperture along the lip being sized to receive the engaging structure of the attachment mechanism, and the upper portion of the aperture along the upper elbow being sized to rotate about a portion of the vertical support of the attachment mechanism.

9. The versatile hanging system of claim 8, further comprising a j-hook having an engaging mechanism at the upper end thereof, wherein the hanging mechanism further comprises one or more apertures through the vertical bar, the apertures being sized to receive the engaging mechanism of the j-hook.

10. A versatile hanging system for use with a roof support system, having a plurality of roof plates with eye holes, the system comprising an attachment mechanism configured to secure within the eye hole of the roof plate, wherein the mechanism comprises:
a. a horizontal support and a vertical support;
b. wherein the vertical support has an engaging structure at a first end thereof; and
c. wherein the horizontal support is affixed to the vertical support at a point a distance from the top of the vertical support, the distance being about the thickness of the roof plate; and
d. wherein the horizontal support has a tapered height, tapering from its affixation with the vertical support to the opposing end of the horizontal support.

11. The versatile hanging system of claim 1, wherein the engaging structure comprises a bolt head affixed to the bottom of the vertical support.

12. The versatile hanging system of claim 11, wherein the bolt head has a plurality of wings extending therefrom.

13. The versatile hanging system of claim 10, further comprising a j-hook having an upper elbow having a lip, a vertical bar, and a lower elbow, with an aperture along the lip and extending to a portion of the upper elbow, the lower portion of the aperture along the lip being sized to receive the engaging structure of the attachment mechanism, and the upper portion of the aperture along the upper elbow being sized to rotate about a portion of the vertical support of the attachment mechanism.

14. The versatile hanging system of claim 10, further comprising a hanging mechanism having an upper elbow having a lip and a vertical bar, with an aperture along the lip and extending to a portion of the upper elbow, the lower portion of the aperture along the lip being sized to receive the engaging structure of the attachment mechanism, and the upper portion of the aperture along the upper elbow being sized to rotate about a portion of the vertical support of the attachment mechanism.

15. The versatile hanging system of claim 14, further comprising one or more j-hooks having an engaging mechanism at the upper end thereof, wherein the hanging mechanism further comprises one or more apertures through the vertical bar, the apertures being sized to receive the engaging mechanism of the j-hook.
